(19) United States
(12) Patent Application Publication
(10) Pub. No.: US 2025/0313192 A1
(43) Pub. Date: Oct. 9, 2025

(54) CONTROL APPARATUS FOR AN ACTUATOR ARRANGEMENT OF THE VEHICLE, CONTROL ARRANGEMENT WITH THE CONTROL APPARATUS AND PROCESS

(71) Applicant: ZF FRIEDRICHSHAFEN AG, Friedrichshafen (DE)

(72) Inventor: Bharath ARUGADOSS, Koblenz (DE)

(21) Appl. No.: 18/863,103

(22) PCT Filed: May 10, 2023
(86) PCT No.: PCT/EP2023/062467

§ 371 Date: Nov. 5, 2024

(30) Foreign Application Priority Data
May 10, 2022 (DE) 10 2022 204 543.2

(51) Int. Cl. B60W 30/06; B60W 50/00; B60W 50/02; B60W 50/029

(52) U.S. Cl. CPC B60W 30/06; B60W 50/0205; B60W 2050/0008; B60W 2050/0292

(57) ABSTRACT

It is an objective of the invention to improve security of advanced driver assistance systems. This objective is solved by a control apparatus 1 for an actuator arrangement 2 of a vehicle, the control apparatus 1 comprising: a driver module 4 for operating the actuator arrangement 2, a first communication module 6 for receiving first data and a second communication module 7 for receiving second data, whereby the control apparatus 1 is adapted for controlling the actuator arrangement 2 in a first operation mode on basis of the first data together with the second data; whereby the control apparatus 1 is adapted for controlling the actuator arrangement 2 in a second operation mode on basis of second data from the second communication module without the first communication module.

The invention concerns a control apparatus for an actuator arrangement of the vehicle with the features of the preamble of claim 1 as well as a control arrangement comprising said control apparatus.

For realizing advanced driver assistance systems, components of a car must be controllable by signals generated from electronic units, such as microcontrollers and transferred in an analog or digital manner. Consequently, the electronics in a car is the basis for a secure assisted driving. Therefore, the electronics is often realized in a redundant manner in order to compensate occurring errors in generating or transferring the respective signals.

Often actuators in a car are operated by such signals in order to control the car. For assisted driving for example the signals from the accelerator pedal, from the braking pedal and from the steering wheel are substituted by artificial signals in order to control the motor, the brakes and the steering angle of the wheels.

It is an objective of the invention to improve security of advanced driver assistance systems. This objective is solved by a control apparatus comprising the features of claim 1, by a control arrangement comprising the features of claim 12 and by a process comprising the features of claim 14. Preferred or advantageous embodiments of the invention are disclosed by the dependent claims, the description and the figures as attached.

Subject matter of the invention is a control apparatus for controlling an actuator arrangement of the vehicle. The vehicle may be a car, especially an electric and/or hybrid car, a motorcycle, a, trike, a bicycle, especially with a motor, et cetera. The control apparatus is adapted for receiving data and for controlling the actuator arrangement on basis of the received data. The data may comprise analog signals and/or digital data.

The control apparatus comprises at least the following components: a driver module, a first communication module and a second communication module.

The driver module is adapted for operating the actuator arrangement. The driver module provides analog signals and/or digital data, which can be addressed to the actuator arrangement in order to perform actuator positioning movements by the actuator arrangement. The actuator arrangement may comprise at least one actuator. Preferably, the actuator arrangement comprises more than one actuator, which can be operated by the driver module.

The first communication module is adapted for receiving first data. The first communication module is especially embodied as an interface of the control apparatus. The first communication module may be restricted to only receiving first data, preferably the first communication module is adapted to communicate in a bidirectional way.

The second communication module is adapted for receiving second data. The second communication module is especially embodied as an interface of the control apparatus. The second communication module may be restricted to only receiving second data, preferably the second communication module is adapted to communicate in a bidirectional way.

In a first operation mode, the control apparatus is adapted for controlling the actuator arrangement on basis of the first data together with the second data. In order to perform the first operation mode in a correct and/or intended manner, the control apparatus uses at least parts of the first data and of the second data. Thus, the control apparatus needs both interfaces, the first communication module and the second communication module, for the first operation mode.

According to the invention it is proposed, that the control apparatus is adapted for controlling the actuator arrangement in a second operation mode. In the second operation mode the control apparatus controls the actuator arrangement on basis of the second data received by the second communication module. No first data and/or cooperation from the first communication module is needed and/or used in the second operation mode for controlling the actuator arrangement. The second operation mode can for example be used in case the first communication module or a data connection to the first communication module is inactive and/or defective, so that no first data can be received by the control apparatus via the first communication module. Especially, the second operation mode is a fallback mode or a redundant mode in order to allow the controlling of the actuator arrangement also in case the first communication module is not capable of receiving first data.

It is an underlying idea of the invention, that the architecture of the control apparatus is designed, so that at least some failure situations can be compensated without or with only minor reducing the capabilities of the control apparatus. The first and second communication module are used for the first operation mode, which can be seen as a normal operation mode. In case problems occur with the first communication module, the second operation mode represents a way of operating without the first communication module and only using interfaces from the control apparatus, which are already present and/or needed to perform the first operation mode. Therefore, the security of the control apparatus is increased without increasing the number of interfaces and/or the costs of the control apparatus significantly.

In a preferred embodiment of the invention, the actuator arrangement is controlled via the control apparatus by actuator commands. The actuator commands initiate the positioning movements of the actuator arrangement. The actuator commands may comprise commands like open, close, set to a special position, forward, backward, up, down et cetera. In the first operation mode the actuator commands are received by or via the first communication module. In the second operation mode, the actuator commands are received by or via the second communication module. In other words, with the change of the operation mode, also a change of the input interface for the actuator commands is combined. Preferably, the second communication module comprises an input, especially an input pin for receiving the actuator commands. The actuator commands maybe realized as an analog signal. Optionally, the analog signal is multiplexed.

It is furthermore preferred, that feedback data is provided as a feedback, reaction and/or response to the actuator commands. The feedback data may comprise an information about the success or the failure of the actuator commands. Alternatively or additionally, it may comprise an information about the actuator status, like status data or signals, especially the voltage or the current being provided to the respective actuator or an information based on such information. Preferably, the second communication module comprises an output, especially an output pin for providing the feedback data. The feedback data maybe realized as an analog signal. Optionally, the analog signal is multiplexed.

In a possible realization of the invention, the first communication module is a serial interface, especially a serial peripheral interface. Alternatively or additionally, the second communication module is a parallel interface. In the first operation mode, first data is received by the first communication module in a serial manner and/or by the second communication in a parallel manner. It is especially preferred, that the actuator commands are provided in the serial manner and/or via the serial interface. It is further preferred, that the second data comprises status data about the control apparatus or the control arrangement in its entirety.

It is further preferred, that the data content of the second data is different between the first and the second operation mode. In the first operation mode, the actuator commands are received as part of the first data. In the second operation mode, the actuator commands are received as part of the second data.

In a preferred realization of the invention, the driver module comprises at least or exactly two separate submodules for controlling two separate actuators of the actuator arrangement. On the one hand side, a single control apparatus can control two actuators, so that for example for a left and a right brake only one control apparatus is needed. On the other hand side, the two submodules can be coupled in a parallel manner, so that a redundancy for operating a single actuator is achieved.

It is additionally preferred, that the driver module is adapted for receiving signals or status data from the actuator arrangement. Alternatively or additionally it is preferred, that the driver submodules are adapted for receiving signals from the respective actuators. The signals may comprise an information about the success or the failure of the actuator commands. Alternatively or additionally, it may comprise an information about the actuator status, like status data or signals, especially the voltage or the current being provided to the respective actuator or an information based on such information.

With this capability a bidirectional communication between the driver module/driver submodule and the actuator arrangement and/or the actuators are possible, so that the control apparatus may perform a closed loop control of the actuator arrangement/actuators. Alternatively or additionally, open-loop control is possible.

In a preferred embodiment, the actuator arrangement is a brake arrangement for the vehicle and/or the actuators are brake actuators, whereby the brake actuators are embodied to open and/or close the brakes in order to generate a braking force.

In a further preferred embodiment the control apparatus further comprises a third communication module for receiving third data comprising high-level actuator commands from the driver and/or are you human machine interface (HMI) in a third operation mode. In said third operation mode, the high-level actuator commands are transferred via the first communication module to a separate control unit, so that actuator commands for execution of the high-level actuator commands can be provided.

In order to support the communication via the first communication module, the control apparatus comprises a memory area, especially a register, for storing parameters of the control operations, the control arrangement and status variables of the operation modes. The control apparatus is realized, so that the first communication module can access the memory, especially the register. The access comprises the right of reading, writing and amending. Preferably the control apparatus comprises at least one analog-digital-converter for converting signals received by the driver module, especially by the submodules, from the respective actuators.

It is especially preferred, that the control apparatus as described is embodied as an integrated circuit.

Whereas the control apparatus can be used by a large number of applications in a vehicle, it is especially preferred that the control apparatus is used in connection with automated parking. In this case the first operation mode is a highly automated parking HAP-mode and the second operation mode is highly automated parking HAP-error mode. During automated parking, actuators of the brake must be controlled in order to close or open the brakes several times, for example more than 10 times opening and/or more than 10 times closing the brakes. In the first operation mode, the normal mode/HAP-mode, the actuator commands are provided via the first communication module and status data is provided by the second communication module. In case it is not longer possible to receive actuator commands via the first communication module, an error mode/HAP-error mode as the second operation mode is started, whereby the actuator commands are provided via the second communication module.

A further object of the invention is a control arrangement comprising the control apparatus as described and further comprising at least a data processing unit, for example a microprocessor or another ECU (electronic circuit unit), whereby the at least one data processing unit is connected to the first and the second communication module. It is furthermore preferred, that the data processing unit is adapted to provide actuator commands to the first communication module in a first operation mode and to the second communication module in a second operation mode.

It is further preferred, that the data processing unit is adapted to receive the feedback data from the first communication module in the first operation mode and from the second communication module in the second operation mode.

It is preferred, that in the first operation mode a first closed loop control for controlling the actuator arrangement is established by using the first communication module and in a second operation mode a second closed loop control for controlling the actuator arrangement is established by using the second communication module without using the first communication module. The closed loop control is especially defined by providing actuator commands and receiving feedback data.

A further object of the invention is a process for controlling an actuator arrangement with the control apparatus and/or with the control arrangement as described before. It is especially preferred that in the second mode realized as the error mode/HAP-error mode the sequence of automated parking is finished regularly.

Further details, advantages and features of the invention are disclosed by the description of preferred embodiments of the invention and the figures as attached. The figures show:

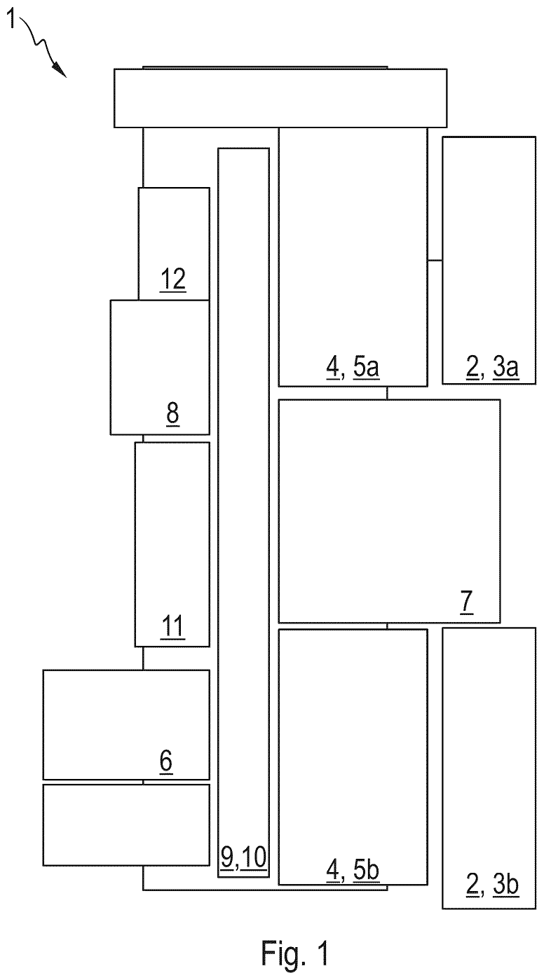

FIG. 1 a block diagram of a control apparatus as an embodiment of the invention;

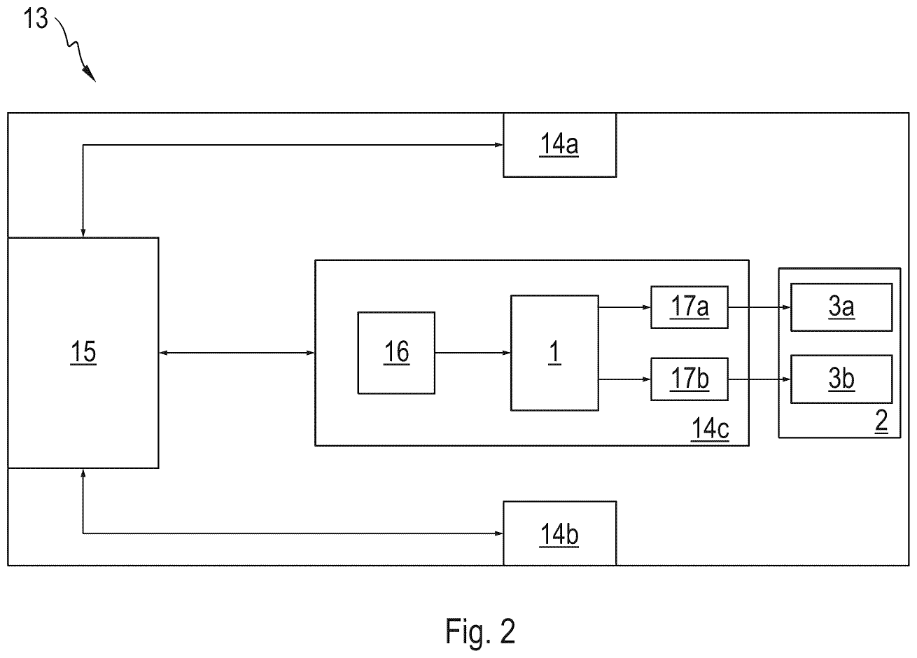

FIG. 2 a block diagram of control arrangement comprising the control apparatus of FIG. 1 as a further embodiment of the invention;

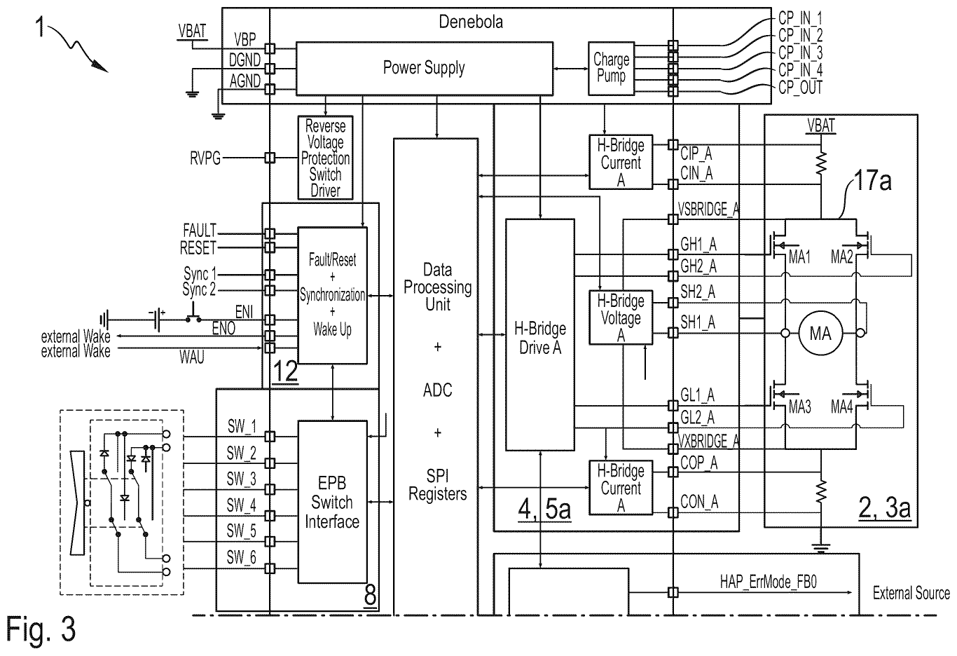

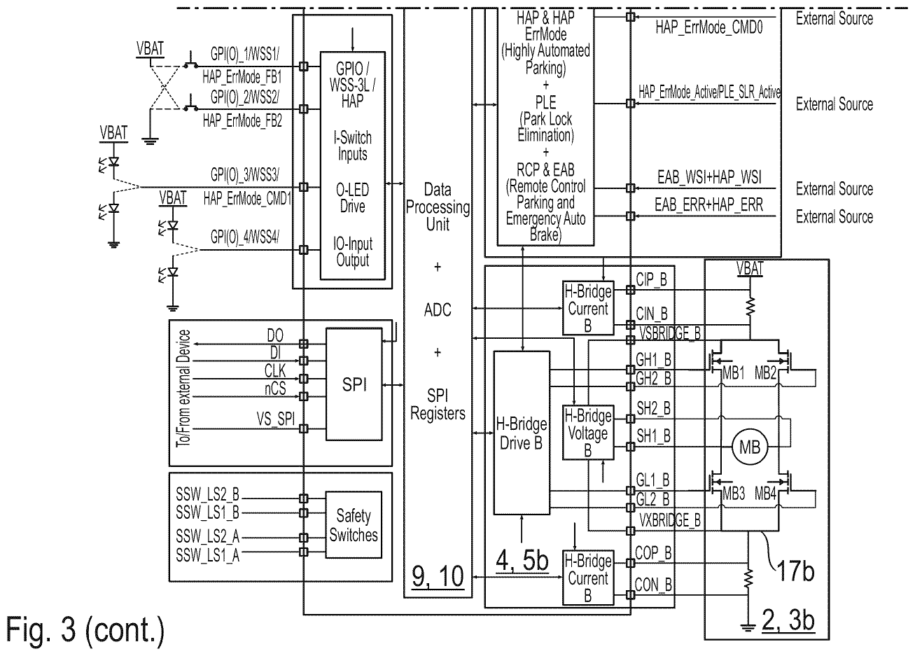

FIG. 3 a detailed block diagram of the control apparatus as already shown in FIG. 1;

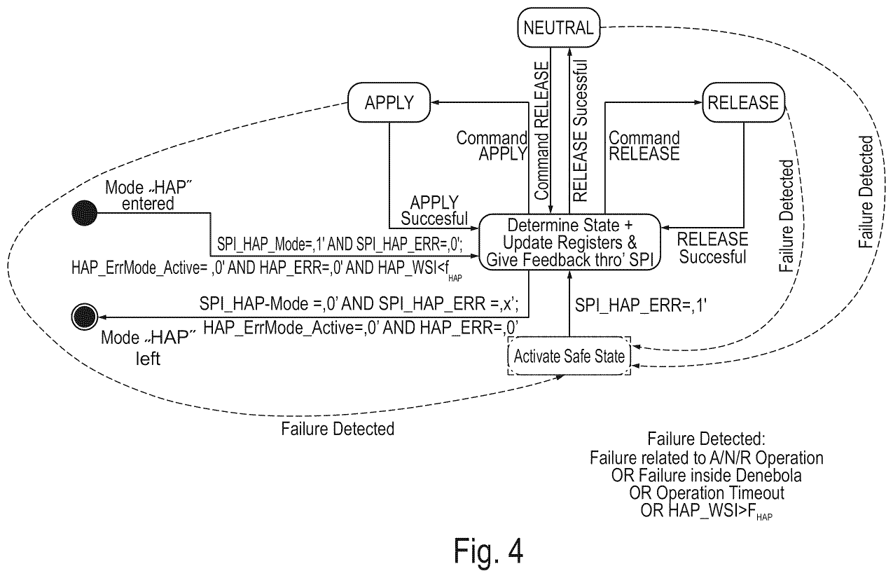

FIG. 4 a state machine diagram of a first operation mode of the control apparatus and/or the control arrangement according to the previous figures;

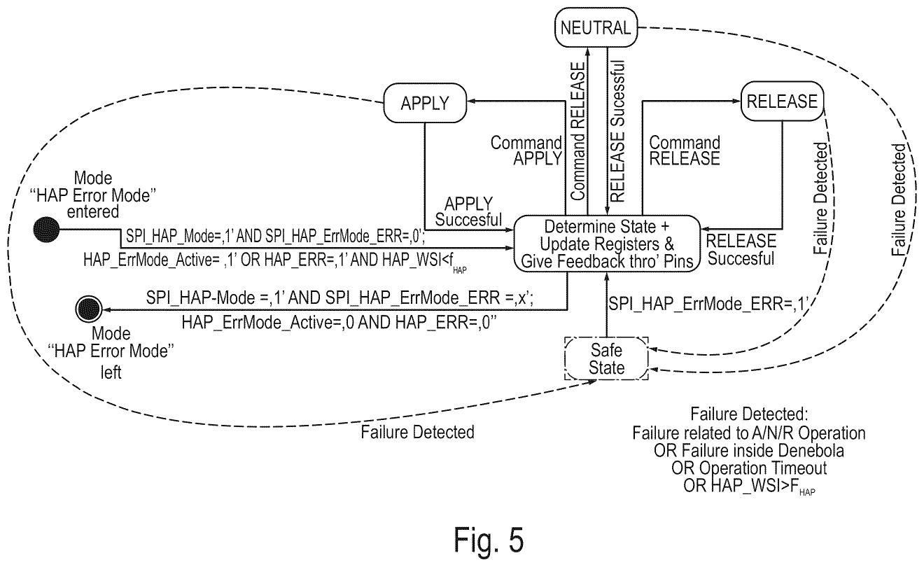

FIG. 5 a state machine diagram of a second operation mode of the control apparatus and/or the control arrangement according to the previous figures;

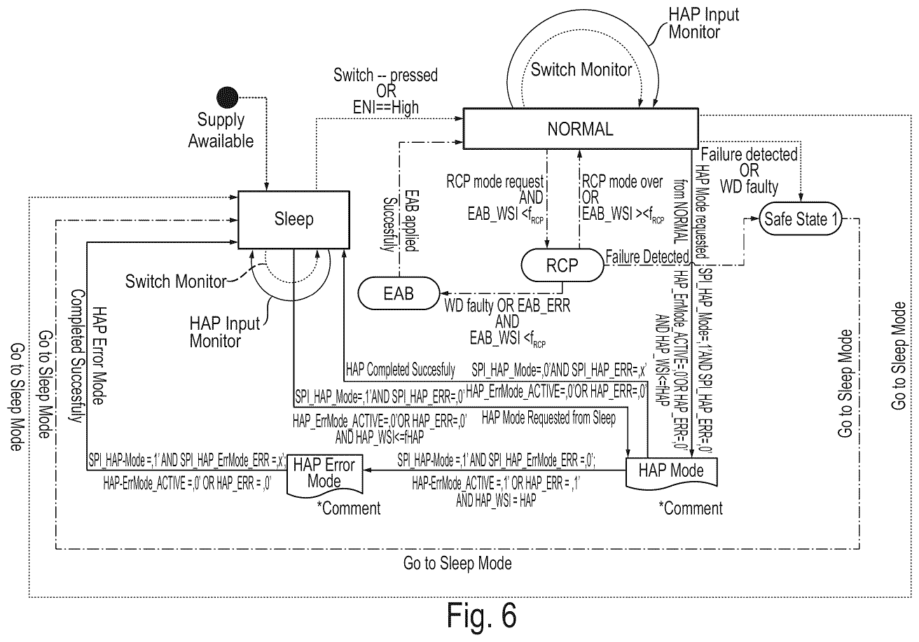

FIG. 6 an overall state machine diagram of the control apparatus and/or the control arrangement according to the previous figures.

FIG. 1 shows a block diagram of a control apparatus 1 (also called Denebola in the following) as an embodiment of the invention. The control apparatus 1 is realized as an integrated circuit. Especially, it is realized as an one-chip integrated circuit, which is based on a single chip.

The control apparatus 1 has the functionality to control an actuator arrangement 2, comprising two actuators 3a, b. The actuators 3a, b are brake actuators in this embodiment, whereby one of the actuators 3a is for braking one wheel and the other of the actuators 3b is for braking another wheel, both wheels belonging to a common axle. The actuators 3a, b are brake actuators, which are used as a static brake and/or as a dynamic brake.

The control apparatus 1 comprises a driver module 4, which comprises two driver submodules 5a and 5b, whereby the submodule 5a is for controlling the actuator 3a and submodule 5a is for controlling the actuator 3b.

The control apparatus 1 comprises a first communication module 6 for receiving first data. The first communication module 6 is additionally adapted for sending data, so that the first communication module 6 is a bidirectional interface. In this embodiment, the first communication module 6 is a serial peripheral interface (SPI).

The control apparatus 1 furthermore comprises a second communication module 7 for receiving second data. The second communication module 7 is additionally adapted for sending or at least providing data, so that the second communication module 7 is a bidirectional interface.

The control apparatus 1 comprises a third communication module 8 for receiving third data. Furthermore, the control apparatus 1 comprises a data processing unit 9.

In a first operation mode, which is a normal (automatic) operation mode, the control apparatus 1 receives first data comprising actuator commands via the first communication module 6, which represents a first interface of the control apparatus 1. Furthermore, the control apparatus 1 receives second data via the second communication module 7, which represents a second interface of the control apparatus 1. The second data comprises status information, parameters, variables et cetera.

In a second operation mode, which is an error operation mode, the control apparatus 1 receives second data comprising the actuator commands via the second communication module 7. No data is received via the first communication module 6 or, alternatively, first data received by the first communication module 6 is discarded.

In a third operation mode, which is a normal (manual) operation mode, the control apparatus 1 receives third data comprising high-level actuator commands via the third communication module 8. The high-level actuator commands are transferred to an external unit to generate actuator commands received by the first or second communication module 6, 7.

The actuator commands received by the first or the second communication module 6,7 are processed by the data processing unit 9 and forwarded to the driver module 4/driver submodules 5a, b for providing command signals for the actuators 3a, b. It shall be underlined, that in the first operation mode, controlling of the actuator arrangement 2 is implemented by using the first communication module 6 and the second communication module 7 as interfaces. In the second operation mode, controlling of the actuator arrangement 2 is implemented by using only the second communication module 7, thereby ignoring first data from the first communication module 6. In case an error occurs relating to the first communication module 6, the second operation mode can be performed only on hardware, which is already present for the first operation mode.

FIG. 2 shows a block diagram of a control arrangement 13 for an advanced driver assistance system. The control arrangement 13 comprises a plurality of electronic circuit units (ECU) 14a, b c, which are controlled by a main electronic circuit unit 15. The main electronic circuit unit 15 provides a software to execute assisted driving, in this example highly automated parking (HAP). The main electronic circuit unit 15 is connected to the electronic circuit units 14a, b, c by an inter ECU Bus, for example CAN. A first electronic circuit unit may be realized as a steering ECU 14a, a second electronic circuit unit may be realized as a transmission ECU 14b and a third electronic circuit unit may be realized as a braking ECU 14c. The braking ECU 14c comprises a braking microcontroller 16 as a data processing unit, the control apparatus 1 is connected to the actuator arrangement 2 as described. Furthermore, the braking EU 14c comprises H-bridges 17a, b as power drivers for the actuators 3a, b, which are controlled by the driver module 4.

The ADAS ECU as main electronic circuit unit 15 would typically hold the software to execute HAP as shown in the following figures. The ADAS ECU 15 would additionally need control of the Transmission, Steering and Braking units 14a, b, c of the car, which is illustrated through the inter-ECU CAN Bus communication.

The ADAS ECU μC SW would know when to activate transmission, steering and the braking ECU 14a, b, c during the HAP sequence. The duration of the HAP operation would be comparable to a manual parking operation.

As far as the Braking Unit 14c and the ECU 15 is concerned, it would receive a series of Brake Apply/Release commands from the ADAS ECU 15, throughout the HAP operation. The braking function itself would typically be performed by the service Brake with the Park Brake acting as a standby in case the service Brake fails to work. The worst case would be the service Brake failing at the first Apply/Release command of the ADAS ECU, after which the park brake will have to complete all the Apply/Release operation (commands) until the HAP is complete

The left and right EPBi Actuators 3a, b are controlled by the Denebola, in a H-Bridge 17a, b setup, as depicted in FIG. 2. The H-Bridge 17a, b and motor details of the actuator 3a, b are depicted in FIG. 3.

In the worst-case scenario, the Denebola receives all of the A/N/R command from the braking μC 16 as shown in FIG. 3, through the SPI interface 6 shown in FIG. 1.

The state machine for the “HAP Mode” is given in FIG. 4 and is explained in “Section 3—HAP Mode”. As shown in the state machine, the A/N/R command is executed, the A/N/R Success/unSuccess Registers updated, and the feedback of every command is received by the Braking μC 16 through the SPI interface 6. If there is an Error in the SPI communication 6 during the “HAP Mode”, the “HAP Error Mode” is activated and is explained in “Section 4—HAP Error Mode”. This is done by pulling the “HAP_ErrMode_Active” pin “HIGH” in FIG. 3. Once this pin goes “HIGH”, the Denebola stops receiving commands through the SPI Interface 6. The Commands for A/N/R are received through the dedicated “HAP Error Mode” Commands pins “HAP_ErrMode_CMDx” pins of the second communication module 7. The Feedback to the Braking μC 16 is given through the dedicated “HAP Error Mode” Feedback pins “HAP_ErrMode_FBx” pins of the second communication module 7.

The state machine for the “HAP Error Mode” is given in FIG. 5. As depicted in the state machine, the commands are received through pins, states determined, commands executed, registers updated and feedback given through the pins. In the “HAP Error Mode”, the Denebola stops the EPB Motor in the Apply and Release Directions once the pre-defined current levels stored in register SPI_APPLY_CUR and SPI_RELEASE_CUR values are reached in the H-Bridge. The stopping of the Motor in the HAP mode is done by the μC SW 16. For details see section 4 and section 5.

Thus, the ADAS ECU 15 would be able to complete the braking function of the HAP sequence, theoretically by the park brake itself. (The assumed worst case being Service Brake failing at the first Apply/Release Command of the ADAS ECU).

### Section 1

FIG. 3 shows an implementation of the control apparatus 1, whereby the same components as in FIG. 1 are referenced by the same reference numbers in FIG. 3.

FIG. 3 shows all the major blocks inside the control apparatus 1 realized as park brake IC.

### Section 1a: Actuator Arrangement 2: H-Bridge 17a, b Description

There are two current sense resistors for each HBridge measuring the entry and exit current of the H-Bridges.

### For H-Bridge A/Submodule 5a/H-Bridge 17a

The central block provides the Drive for H-Bridge A N-MOSFETs MA1, MA2, MA3 and MA4
GH1_A, GH2_A, GL1_A and GL2_A

The smaller blocks provides sense for the H-Bridge A
Input and Exit Current through the differential voltage measurement of the current sense pins. Input current through the pins CIP_A and CIN_A. The exit current through the pins COP_A and CON_A
Motor Voltages represented by SH1_A and SH2_A
The Entry and Exit Voltage of the H-Bridge A represented by VSBRIDGE_A and VXBRIDGE_A respectively

### For H-Bridge B/Submodule 5b/H-Bridge 17a

The central block provides the Drive for H-Bridge B N-MOSFETs MB1, MB2, MB3 and MB4
GH1_B, GH2_B, GL1_B and GL2_B

The smaller blocks provide sense for the H-Bridge B
Input and Exit Current through the differential voltage measurement of the current sense pins. Input current through the pins CIP_B and CIN_B. The exit current through the pins COP_B and CON_B
Motor Voltages represented by SH1_B and SH2_B
The Entry and Exit Voltage of the H-Bridge B represented by VSBRIDGE_B and VXBRIDGE_B respectively

### Section 1b: Remaining Blocks in the Block Diagram

VBAT represents the Battery Supply of the Car. A charge Pump is required to turn on the HS MOSFET's of the H-Bridges (MA1, MA2, MB1 and MB2).

The first communication module 6 as a SPI used to connect to the braking microcontroller 16 and SPI registers as memory 10 in the control apparatus 1 are written and read through the interface/first communication module 6.

The Pins of a general input 11 are shared between the GPIO (General Purpose Input Output), WSS (Wheel Speed Sensor Interface) and HAP (Highly Automated Parking). The pins need to be multiplexed for want of fitting into a 64-pin package

The third communication module 8 represents the EPB (Electronic parking brake) switch interface, for getting the driver Input Apply-Neutral-Release as actuator commands.

The fault/reset communication block 12 represents fault/reset communication between the μC 16 and the control apparatus 1. It also has signals to wakeup the μC 16 when the control apparatus 1 switch Interface is activated in the sleep mode

The central Box represent the data Processing unit 9, ADC (analog-to-digital converter) and the SPI registers as memory 10. All the analog sense signals of the H-Bridge
Input Current
Output Current
Motor Voltages
Input & Exit HBridge Voltages
   are sampled by the ADC and saved in the corresponding SPI registers for transport to the μC 16 through the SPI interface 6.

### Section 2: Third Operation Mode: Normal Manual Operation Mode

Once the Driver presses “Apply” as a high level actuator command, the third communication module 8 receives the signal, it is then decoded by the ECU (electronic control unit 14c) and μC SW (microcontroller 16 software) that an “Apply” has been requested. The μC SW (microcontroller 16 software) would then Request an “Apply” of the Park Brake/actuator arrangement 2 to the control apparatus 1 (IC). The control apparatus 1 (IC) would then turn ON the Park Brake Motors/actuators 3a, b in the Apply Direction. For H-Bridge A this would then mean turning ON the NFET's MA1 & MA4 and for H-bridge B this would mean turning ON the NFET's MB1 & MB4—thereby rotating the Park Brake Motor/actuators 3a,b in the Apply Direction.

The μC SW (microcontroller 16 software) would continuously monitor the H-Bridge Voltage and Current, through the ADC values supplied through the SPI Interface/first communication module 6, by the IC/control apparatus 1. The force generated by the Braking Caliper on the wheels of the car is directly proportional to the product of Voltage and Current of the H-Bridge. The actual force required on the wheels is a function of several variables which includes inclination, Weight of the Car, Motor and Caliper factors etc.

The μC 16 SW (microcontroller software) would continuously monitor the current and voltage of the ADC the product of which is proportional to the Braking Force. Once the pre-determined force is reached, the μC SW (microcontroller software) requests the IC/control apparatus 1 to turn OFF the Park Brake Motor. The control apparatus 1/IC would then turn OFF the Park Brake Motors/actuators 3a,b in the Apply Direction. For H-Bridge A this would mean turning OFF the NFET'S MA1 & MA4 and for H-Bridge B this would mean turning OFF the NFET's MB1 & MB4-thereby stopping the rotating of the Park Brake in the Apply Direction, achieving the necessary braking force between the Caliper and the wheel.

Once the Driver presses Release as a high level actuator command, the third communication module 8 receives the signal, it is then decoded by the ECU (electronic control unit 14c) and C SW (microcontroller 16 software) that a Release has been requested. The μC SW (microcontroller 16 software) would then Request a Release of the Park Brake to the control apparatus 1. The control apparatus 1 would then Turn ON the Park Brake Motors/actuators 3a, b in the Release Direction. For H-Bridge A this would mean turning ON the NFET's MA2 & MA3 and for H-Bridge B this would mean turning ON the NFET's MB1 & MB4—thereby rotating the Park Brake Motor/actuators 3a, b in the Release Direction.

The μC SW (microcontroller software) would continuously monitor the H-Bridge Voltage and Current, through the ADC values supplied through the SPI interface, by the IC. A sufficient caliper clearance and the Release Current are interlinked. The μC SW (microcontroller software) knows precisely when to Turn OFF the motors/actuators 3a,b. A command is sent to the control apparatus 1 to stop the Motors/actuators 3a, b. The control apparatus 1 would then Turn OFF the Park Brake Motors/actuators 3a, b in the Release Direction. For H-Bridge A this would mean turning OFF the NFET's MA2 & MA3 and for H-Bridge B this would mean turning OFF the NFET's MB2 & MB3—Thereby stopping the rotating of the Park Brake in the Release direction, achieving the clearance required between the Caliper and the Wheel

### Section 3: First Operation Mode/HAP (Highly Automated Parking)

The HAP is usually activated with the Driver outside the car. But the driver can also be inside the Car. The HAP is activated when the driver drives to the parking lot OR when the car is parked in the parking lot.

FIG. 4 shows the HAP state machine. The HAP is activated by setting the SPI bit of the memory 10, SPI_HAP_Mode to ‘1’, at the same time the HAP Error bit should NOT be set, SPI_HAP_ERR=‘0’. External Signals to the pins HAP_ErrMode_ACTIVE & HAP_ERR should be Driven LOW of the second communication unit 7. Additionally, the vehicle speed should be less than F_{HAP}. This is shown in the FIG. 6 as HAP_WSI<f_{HAP} to enter the HAP state. This is verified by the control apparatus 1 through the pin input HAP_WSI of the second communication module 7.

When the driver, outside the Car, activates HAP through the Key chain, there are many Apply/Neutral/Release Request to the control apparatus 1 from the Braking ECU 14c it resides in. The HAP State machine will be activated by the control apparatus 1 and this will be described in this section.

There are a bunch of SPI Registers of the memory 10 which are newly required to execute HAP. The meaning of them given below: SPI_HAP_SUC_AREG and SPI_HAP_USUC_AREG are complimentary registers for safety purpose. Both registers store the status of last 16 Apply command. The SPI_HAP_SUC_AREG bit is set if the Apply command is successful and the SPI_HAP_USUC_AREG bit is set if the Apply command is unsuccessful. Note that bits in both Registers are complimentary to one another i.e. both never have their same bits the same value. SPI_HAP_SUC_NREG and SPI_HAP_USUC_NREG are complimentary registers for safety purpose. Both registers store the status of last 16 Neutral command. The SPI_HAP_SUC_NREG bit is set if the Neutral command is successful and the SPI_HAP_USUC_NREG bit is set if the Neutral command is unsuccessful. Note that bits in both Registers are complimentary to one another i.e. both never have their same bits the same value.

SPI_HAP_SUC_RREG and SPI_HAP_USUC_RREG are complimentary registers for safety purpose. Both registers store the status of last 16 Release command. The SPI_HAP_SUC_RREG bit is set if the Release command is successful and the SPI_HAP_USUC_RREG bit is set if the Release command is unsuccessful. Note that bits in both Registers are complimentary to one another i.e. both never have their same bits the same value.

There are 3× more 16-bit registers to store the HBridge current value at which the Apply/Neutral/Release will be stopped in HAP Error Mode. Please see HAP Error Mode for more details

The FIG. 4 shows the state diagram for the HAP.

In the HAP mode, the Car is parked automatically with the driver outside the car. HAP is executed through SPI. The A/N/R command does not come from the driver through the switch interface of the third communication module 8. The ECU SW of the main electronic circuit unit 15 and/or the electronic circuit unit 14c decides when the command for A/N/R should be sent to the control apparatus 1 and this command comes to the through the SPI interface/first communication module 6. When the Apply command comes, the control apparatus 1 activates the Motor MA (MB)/actuators 3a,b, by turning ON the MOSFET's MA1 and MA4 (MB1 and MB4). The H-Bridge A (H-Bridge B) current is monitored by the SW and when sufficient Parking Force is created the ECU sends a command to STOP the Motor. Once the STOP command is received by control apparatus 1, the control apparatus 1 turns OFF the MOSFET's MA1 and MA4 (MB1 and MB4).

Similarly, a Neutral and Release command is executed

When there is an error when executing the A/N/R command, (Error defined in the state diagram), the SPI_HAP_Error bit will be set. Note that the “HAP Error Mode” is not activated here.

### HAP Mode Enter State Values; A/N/R Status Register Values

SPI_HAP_Mode=‘1’
SPI_HAP_ERR=‘0’;
SPI_HAP_SUC_AREG[15:0]=‘0000 0000 0000 0000’;
SPI_HAP_USUC_AREG[15:0]=‘0000 0000 0000 0000’;
SPI_HAP_SUC_NREG[15:0]=‘0000 0000 0000 0000’;
SPI_HAP_USUC_NREG[15:0]=‘0000 0000 0000 0000’;
SPI_HAP_SUC_RREG[15:0]=‘0000 0000 0000 0000’;
SPI_HAP_USUC_RREG[15:0]=‘0000 0000 0000 0000’;

Inital state values shown before the start of HAP.

Each time HAP is started the Registers are Cleared
SPI_APPLY_CUR[15:0];
SPI_NEUTRAL_CUR[15:0];
SPI_RELEASE_CUR[15:0];

### HAP Mode Exit State Values; A/N/R Status Register Values

SPI_HAP_Mode=‘1’
SPI_HAP_ERR=‘x’;
SPI_HAP_SUC_AREG[15:0]=‘xxxx xxxx xxxx xxxx’; SPI_HAP_USUC_AREG[15:0]=‘xxxx xxxx xxxx xxxx’;
SPI_HAP_SUC_NREG[15:0]=‘xxxx xxxx xxxx xxxx’;
SPI_HAP_USUC_NREG[15:0]=‘xxxx xxxx xxxx xxxx’;
SPI_HAP_SUC_RREG[15:0]=‘xxxx xxxx xxxx xxxx’;
SPI_HAP_USUC_RREG[15:0]=‘xxxx xxxx xxxx xxxx’;

When Sucessful the A/N/R SPI_HAP_SUC_xREG bit is changed to ‘1’

When Unsucessful the A/N/R SPI_HAP_USUC_xREG bit is changed to ‘1’

x indicates the value can be either ‘0’ OR ‘1’

### Abbreviation

SPI—Serial Peripheral Interface
HAP—Highly Automated Parking
ERR—Error
WSI—Wheel Speed Input
μC SW—Micro-Controller Software
Control apparatus 1—ZF Next Generation Park Brake IC
fHAP—Wheel Speed when HAP is requested
ErrMode—Error Mode
SUC—Success
USUC—Unsuccess/Not Successful
AREG—Apply Register
NREG—Neutral Register
RREG—Release Register
CUR—Current

### Registers

SPI_HAP_Mode: μC SW Programmed bit in Control apparatus 1; SPI Bit to indicate that HAP is Active; Control apparatus 1 cannot change the Bit value
SPI_HAP_Mode=‘0’; HAP State Machine is NOT Active
SPI_HAP_Mode=‘1’; HAP State Machine is Active
SPI_HAP_ERR=‘0’; μC SW cleared bit at the beginning of HAP Mode operation;

The bit stores the information of success/failure of the last HAP Mode command. The Bit is overwritten by Control apparatus 1 during HAP Mode
SPI_HAP_ERR=‘0’; The last HAP Mode command was successful
SPI_HAP_ERR=‘1’; The last HAP Mode command was unsuccessful
SPI_HAP_SUC_AREG[15:0]: SPI Register to store last 16 times status of Apply.

When Successful the bit is turned to ‘1’. Otherwise left to ‘0’;
SPI_HAP_USUC_AREG[15:0]: SPI Register to store last 16 times status of Apply.

When Unsuccessful the bit is turned to ‘1’. Otherwise left to ‘0’;
SPI_HAP_SUC_NREG[15:0]: SPI Register to store last 16 times status of Neutral.

When Successful the bit is turned to ‘1’. Otherwise left to ‘0’;
SPI_HAP_USUC_NREG[15:0]: SPI Register to store last 16 times status of Neutral.

When Unsuccessful the bit is turned to ‘1’. Otherwise left to ‘0’;
SPI_HAP_SUC_RREG[15:0]: SPI Register to store last 16 times status of Release.

When Successful the bit is turned to ‘1’. Otherwise left to ‘0’;
SPI_HAP_USUC_RREG[15:0]: SPI Register to store last 16 times status of Release.

When Unsuccessful the bit is turned to ‘1’. Otherwise left to ‘0’;
SPI_APPLY_CUR[15:0]: SPI Register to store value of Apply Current at which value the EPB Motor will be switched off in case “HAP Error Mode” is entered
SPI_NEUTRAL_CUR[15:0]: SPI Register to store value of Neutral Current at which value the EPB Motor will be switched off in case “HAP Error Mode” is entered
SPI_RELEASE_CUR[15:0]: SPI Register to store value of Release Current at which value the EPB Motor will be switched off in case “HAP Error Mode” is entered

### Pin Info of Second Communication Module 7

HAP_WSI: INPUT PIN: Wheel Speed Input from ECU
HAP_ERR: INPUT PIN: Active HIGH; Input to indicate Error in HAP Mode and
Request to enter “HAP Error Mode”; HAP Error Mode State Machine Active when Input HIGH
HAP_ERR Pin Input for Application SW to check HAP Error Mode
HAP_ERR=‘0’; Control apparatus 1 DOES NOT Enter the HAP Error Mode
HAP_ERR=‘1’; Control apparatus 1 Enters the HAP Error Mode
HAP_ErrMode_Active: INPUT PIN Active HIGH; Input to indicate Error in HAP Mode and Request to enter “HAP Error Mode”; HAP Error Mode State Machine Active when Input HIGH
HAP_ErrMode_Active Pin Input in Real Application to go intp HAP Error Mode
HAP_ErrMode_Active=‘0’; Control apparatus 1 DOES NOT Enter the HAP Error Mode
HAP_ErrMode_Active=‘1’; Control apparatus 1 Enters the HAP Error Mode

### Section 4: HAP (Highly Automated Parking) Error Mode as Second Operation Mode

FIG. 5 shows the State Machine HAP Error Mode. The State Machine is activated when SPI_HAP_Mode bit is SET and either of the external pin signals HAP_ErrMode_ACTIVE OR HAP_ERR is driven HIGH. The difference is HAP_ERR is a signal for the μC SW to check the HAP Error Mode and the HAP_ErrMode_ACTIVE is a signal during real application

The Mode is activated from the ECU depending on the failure condition for e.g. a broken SPI communication between the ECU μC and the control apparatus 1 during HAP. (There can be several failure conditions in the ECU during HAP, when the HAP Error Mode is activated, which is not detailed here). In this mode, the A/N/R command comes through the IC PINS of the second communication module 7 of the control apparatus 1, instead of the SPI/first communication module 6. The list of Registers and Pins that are used in this mode are given in the following.

The control apparatus 1 performs the A/N/R operation, just as in the HAP mode when the corresponding command is received through the pins. The commands are received in the control apparatus 1 through the pins HAP_ErrMode_CMD[1,0]. The possible inputs and their meaning are given in the state diagram and the following. Each time the command is received, the corresponding operation is performed, the SPI registers/memory 10 are updated, and the feedback is given through the pins of the second communication module 7. Note that the SPI register values cannot be read by the μC 16 SW as the communication interface (first communication module 6) between the μC 16 and the control apparatus 1 is dead.

The feedback is given back to the ECU 14c through the pins HAP_ErrMode_FB[2 . . . 0] of the second communication module 7. The possible inputs and their meaning are given in the following.

If there is an error in A/N/R operation, the corresponding SUC and USUC registers are updated. The failure feedback is given back to the ECU 14c. Only the μC 16 SW decides what to do next upon an error in the A/N/R operation, during the HAP Error Mode (& also HAP). Note that there is the SPI bit SPI_HAP_ErrMode_ERR to store the SUC/USUC of the last command. When Successful this bit is set to ‘0’ and when Unsuccessful this bit is set to ‘1’. This can be seen in the state diagram when exiting the safe state in case of an error in the operation. A failure is defined as an error in the activation of the Park Brake Motor actuator 3a, b in A/N/R OR a specific failure in the control apparatus 1 which is programed at the start of the HAP operation OR an Operation Timeout. If at any time the speed of the vehicle, which is received through the pins HAP_WSI of the second communication module 7 is above the FHAP, the A/N/R operation is not performed, and an error reported to the ECU. Note that when exiting the HAP Error Mode, the SPI_HAP_Mode still remains ‘1’, as the μC and Control apparatus 1 SPI communication is broken.

### HAP Error Mode Enter State Values; A/N/R Status Register Values

SPI_HAP_Mode=‘1’;
SPI_HAP_ErrMode_ERR=‘0’;
SPI_HAP_SUC_AREG[15:0]=‘xxxx xxxx xxxx xxxx’; SPI_HAP_USUC_AREG[15:0]=‘xxxx xxxx xxxx xxxx’;
SPI_HAP_SUC_NREG[15:0]=‘xxxx xxxx xxxx xxxx’;
SPI_HAP_USUC_NREG[15:0]=‘xxxx xxxx xxxx xxxx’;
SPI_HAP_SUC_RREG[15:0]=‘xxxx xxxx xxxx xxxx’;
SPI_HAP_USUC_RREG[15:0]=‘xxxx xxxx xxxx xxxx’;

Inital state values shown before the start of HAP Error Mode.

Since HAP was started already, each register would store the last 16 times status of HAP to begin with.

x indicates the value can be either ‘0’ OR ‘1’
SPI_APPLY_CUR[15:0];
SPI_NEUTRAL_CUR[15:0];
SPI_RELEASE_CUR[15:0];

### HAP Error Mode Exit State Values; A/N/R Status Register Values

SPI_HAP_Mode=‘1’;
SPI_HAP_ErrMode_ERR=‘x’;

Since the Control apparatus 1 cannot change the value of the SPI_HAP_Mode bit and the SPI communication between the μC SW and the Control apparatus 1 is broken the bit will remain ‘1’ when exiting the “HAP Error Mode”

SPI_HAP_ErrMode_ERR will store the value of the last “HAP Error Mode” command. When successful it would have stored ‘0’ and when unsuccessful it would have stored ‘1’
SPI_HAP_SUC_AREG[15:0]=‘xxxx xxxx xxxx xxxx’; SPI_HAP_USUC_AREG[15:0]=‘xxxx xxxx xxxx xxxx’;
SPI_HAP_SUC_NREG[15:0]=‘xxxx xxxx xxxx xxxx’;
SPI_HAP_USUC_NREG[15:0]=‘xxxx xxxx xxxx xxxx’;
SPI_HAP_SUC_RREG[15:0]=‘xxxx xxxx xxxx xxxx’;
SPI_HAP_USUC_RREG[15:0]=‘xxxx xxxx xxxx xxxx’;

When Successful the A/N/R SPI_HAP_SUC_xREG bit is changed to ‘1’

When Unsuccessful the A/N/R SPI_HAP_USUC_xREG bit is changed to ‘1’

x indicates the value can be either ‘0’ OR ‘1’

### Abbreviation

SPI—Serial Peripheral Interface
HAP—Highly Automated Parking
ERR—Error
WSI—Wheel Speed Input
μC SW—Micro-Controller Software
Denebola—ZF Next Generation Park Brake IC
fHAP—Wheel Speed when HAP is requested
ErrMode—Error Mode
SUC—Success
USUC—Unsuccess/Not Successful
AREG—Apply Register
NREG—Neutral Register
RREG—Release Register
CUR—Current
CMD—Command
FB—Feedback
SPI—Serial Peripheral Interface
HAP—Highly Automated Parking
ER—Error
WSI—Wheel Speed Input
μC SW—Micro-Controller Software
Denebola—ZF Next Generation Park Brake IC

### Registers

SPI_HAP_Mode: μC SW Programmed bit in Denebola; SPI Bit to indicate that HAP is Active; Denebola cannot change the Bit value

SPI_HAP_Mode=‘0’; HAP State Machine is NOT Active

SPI_HAP_Mode=‘1’; HAP State Machine is Active

SPI_HAP_ErrMode_ERR=‘0’; μC SW cleared bit at the beginning of HAP Error Mode operation; The bit stores the information of success/failure of the last HAP Error Mode command. The Bit is overwritten by Denebola during HAP Error Mode SPI_HAP_ErrMode_ERR=‘0’; The last HAP Error Mode command was successful SPI_HAP_ErrMode_ERR=‘1’; The last HAP Error Mode command was unsuccessful SPI_HAP_SUC_AREG[15:0]: SPI Register to store last 16 times status of Apply.

When Successful the bit is turned to ‘1’. Otherwise left to ‘0’;
SPI_HAP_USUC_AREG[15:0]: SPI Register to store last 16 times status of Apply.

When Unsuccessful the bit is turned to ‘1’. Otherwise left to ‘0’;
SPI_HAP_SUC_NREG[15:0]: SPI Register to store last 16 times status of Neutral.

When Successful the bit is turned to ‘1’. Otherwise left to ‘0’;
SPI_HAP_USUC_NREG[15:0]: SPI Register to store last 16 times status of Neutral.

When Unsuccessful the bit is turned to ‘1’. Otherwise left to ‘0’;
SPI_HAP_SUC_RREG[15:0]: SPI Register to store last 16 times status of Release.

When Successful the bit is turned to ‘1’. Otherwise left to ‘0’;
SPI_HAP_USUC_RREG[15:0]: SPI Register to store last 16 times status of Release.

When Unsuccessful the bit is turned to ‘1’. Otherwise left to ‘0’;
SPI_APPLY_CUR[15:0]: SPI Register stores value of Apply Current & Profile at which value the EPB Motor will be switched off when commanded Apply;
SPI_NEUTRAL_CUR[15:0]: SPI Register stores value of Neutral Current & Profile at which value the EPB Motor will be switched off when commanded Neutral
SPI_RELEASE_CUR[15:0]: SPI Register stores value of Release Current & Profile at which value the EPB Motor will be switched off when commanded Release

### Pin Info of Second Communication Module 7

HAP_WSI: INPUT PIN: Wheel Speed Input from ECU
HAP_ERR: INPUT PIN: Active HIGH; Input to indicate Error in HAP Mode and Request to enter “HAP Error Mode”; HAP Error Mode State Machine Active when Input HIGH
HAP_ERR Pin Input for Application SW to check HAP Error Mode
HAP_ERR=‘0’; Denebola DOES NOT Enter the HAP Error Mode
HAP_ERR=‘1’; Denebola Enters the HAP Error Mode
HAP_ErrMode_Active: INPUT PIN Active HIGH; Input to indicate Error in HAP Mode and Request to enter “HAP Error Mode”; HAP Error Mode State Machine Active when Input HIGH
HAP_ErrMode_Active Pin Input in Real Application to go into HAP Error Mode
HAP_ErrMode_Active=‘0’; Denebola DOES NOT Enter the HAP Error Mode
HAP_ErrMode_Active=‘1’; Denebola Enters the HAP Error Mode
HAP_ErrMode_CMD1: HAP_ErrMode_CMD0: INPUT PIN
HAP_ErrMode_CMD[1,0]=“11” à Command NEUTRAL
HAP_ErrMode_CMD[1,0]=“10” à Command RELEASE
HAP_ErrMode_CMD[1,0]=“01” à Command APPLY
HAP_ErrMode_CMD[1,0]=“00” à NOT ASSIGNED
HAP_ErrMode_FB2: HAP_ErrMode_FB1: HAP_ErrMode_FB0: OUTPUT PIN
HAP_ErrMode_FB[2 . . . 0]=“111” à NEUTRAL Successful
HAP_ErrMode_FB[2 . . . 0]=“110” à RELEASE Successful
HAP_ErrMode_FB[2 . . . 0]=“101” à APPLY Successful
HAP_ErrMode_FB[2 . . . 0]=“100” à Denebola Error1; Pre-Programmed by μC SW when entering HAP Mode;
HAP_ErrMode_FB[2 . . . 0]=“011” à NEUTRAL Unsuccessful
HAP_ErrMode_FB[2 . . . 0]=“010” à RELEASE Unsuccessful
HAP_ErrMode_FB[2 . . . 0]=“001” à APPLY Unsuccessful
HAP_ErrMode_FB[2 . . . 0]=“000” à Denebola Error0; Pre-Programmed by μC SW when entering HAP Mode

### Section 5: FIG. 6: Global State Machine

FIG. 6 shows the global State Machine of the control apparatus 1. The Normal Mode is shown in dotted lines.

The RCP (Remote Control Parking Mode), with EAB (Emergency Auto Brake), with One Apply and One Release is shown in dotdashed lines.

The HAP and HAP error Mode is shown in solid lines.

HAP Mode: The HAP mode is activated by the Driver both inside and outside the car.

When inside the IGN can be ON/OFF. IGN ON would be a HAP request from NORMAL mode. IGN OFF would be HAP request form Sleep mode. When outside the IGN is OFF and the HAP is requested from SLEEP mode.

As explained in the HAP flow chart the HAP is activated through the Key-Chain of the Driver (OR an App in Mobile etc.) when the Driver is outside the car. When Inside the car, apart from the above methods, an additional button would be there to activate HAP. All of this is presented in the State Machine as the HAP Input Monitor in both SLEEP and NORMAL mode.

When HAP activated from NORMAL mode, the ECU would be awake and the μC SW 16 would already be active. The μC SW 16 would SET the bit SPI_HAP_mode in Denebola and this bit cannot be changed by Denebola. The SPI_HAP_ERR is an internal status bit in Denebola which represent the status of the last HAP command A/N/R. To begin with this bit is cleared by the μC SW 16. Note the external PIN signals HAP_ErrMode_ACTIVE and HAP_ERR which active the “HAP Error Mode” are LOW. The Wheel Speed information from the ECU is received by the Denebola—A Freq. Modulated Digital Signal between 0 KHz-2.5 KHz which indicate the Speed of the car. This is represented in the State Diagram as f_{HAP}.

During the Highly Automated Parking (HAP) sequence/process, the Denebola receives a sequence of A/N/R commands, through the SPI interface from the μC Software. The Denebola checks if the wheel speed received through the pin HAP_WSI<fHAP, a pre-determined value by the system. If yes, then the Park Brake Motor is actuated as per input SPI command. If not, the Park Brake Motor is not actuated and the SPI_HAP_ERR bit is SET. The list of registers used, and the entire process is explained in the section 3: HAP Highly Automated Parking, which elaborates the HAP Mode State Machine

The last command in the HAP operation is an Apply, to get the car in a safe state. The μC SW would flip the SPI_HAP_Mode to ‘0’, which would indicate a successful end of the HAP sequence. The system would then enter the SLEEP mode When HAP activated from the SLEEP mode, the EPB Switch interface will detect the key press and an ENI (Enable Input) will be generated as an input the Denebola Wake Up (YELLOW) Block. An ENO (Enable Output) will be generated by Denebola to wakeup the ECU as shown in the Yellow Block. Once the ECU and the μC SW are ready a WAU (Wakeup) signal is generated by the ECU to wakeup the Denebola.

Once the Denebola wakes up the SPI interface is ready and the communication between the μC and Denebola starts. The rest is similar to the HAP activated from NORMAL and the Denebola is in the HAP mode.

The last command in the HAP operation is an Apply, to get the car in a safe state. The μC SW would flip the SPI_HAP_Mode to ‘0’, which would indicate a successful end of the HAP sequence. The system would then enter the SLEEP mode

HAP Error Mode: If there is an Error during the HAP mode, a failure in the SPI communication between the μC SW and SPI interface of Denebola, a HAP Error Mode is activated and is shown in the state diagram. The problem here being that the A/N/R command as actuator commands to the Denebola cannot be anymore given by the SPI Interface.

In “HAP Error Mode”, the commands for the A/N/R as actuator commands come through the PIN interface/second communication module 7 of Denebola from the ECU and the results of the execution of the commands are given out through the PIN interface of Denebola to the ECU. A switch to the “HAP Error Mode” is indicated by the activation of either of the Pins, HAP_ErrMode_ACTIVE OR HAP_ERR to HIGH The HAP_ErrMode_ACTIVE is used in real application scenario and the HAP_ERR is used by software to check that the “HAP Error Mode” works correctly.

As the “HAP Error Mode” is activated from the “HAP Mode” the SPI_HAP_Mode is still ‘1’. As in the “HAP Mode” there is a bit to store the value of Success/Failure of the last HAP command—SPI_HAP_ErrMode_ERR and this is cleared during the beginning of the “HAP Mode” and overwritten by Denebola during the “HAP Error Mode”

The Pins and Registers and the “HAP Error Mode” process is described in Section 4: HAP (Highly Automated Parking) Error Mode.

Note that when exiting the HAP Error Mode, the SPI bit SPI_HAP_Mode still remains ‘1’, as the bit cannot be altered by Denebola and the SPI interface between the μC and the Denebola is DEAD

Note also that a single command failure in A/N/R in “HAP Mode” does NOT automatically active the HAP Error Mode. Failures in the HAP Mode commands are handled by the μC SW as noted in the comment. Also, failures in the “HAP Error Mode” commands are handled by the μC SW and failure reaction is pre-defined in the μC System SW

The last command in the “HAP Error Mode” operation is an Apply, to get the car in a safe state. The μC SW would NOT flip the SPI_HAP_Mode to ‘0’. The success of this last command would indicate a successful end of the “HAP Error Mode” sequence. The system would then enter the SLEEP mode

NORMAL Mode: The current generation feature is given in dotted lines. The parking operation is typically a SINGLE command from N-->A OR N-->R. The Driver is inside the car. If IGN is OFF, then system is in SLEEP mode. If IGN is ON, system is awake and in NORMAL mode. The EPB Switch Interface (third communication module 8 in FIG. 1/2), is active in SLEEP mode and facilitates a transition from SLEEP to NORMAL mode. A switch press is detected, and an ENI (Enable Input) signal is generated into the Wakeup Block (YELLOW BLOCK in FIG. 1) of the Denebola. In response to the ENI signal, the Denebola generates a ENO (Enable Output) signal to wake-up the ECU and the μC. Once the system is awake, a WAU (Wakeup) signal is generated for the Denebola by the ECU. Once the Denebola is awake the SPI interface between the μC and Denebola is active. The system is then in NORMAL mode. The command for A OR N OR R is received by the Denebola and accordingly both the Park Brake Motors in the H-Bridges are executed.

RCP Mode: An RCP (Remote Control Parking) mode can be requested from the NORMAL Mode. In the RCP mode, the Driver is inside the Car. The RCP is executed with multiple request for A/N/R. An error (Error defined in the State Diagram) in the operation immediately activates the EAB (Emergency Auto Brake) with a Apply. During the RCP, the Denebola additionally checks that the vehicle speed is less than fRCP for A/N/R of the Park Brake Motor.

### REFERENCE NUMBERS

1 control apparatus
2 actuator arrangement
3a, b actuators
4 driver module
5a, b submodules
6 first communication module
7 second communication module
8 third communication module
9 data processing unit
10 memory
11 general input
12 fault/reset communication block
13 control arrangement
14a, b, c electronic circuit unit (ECU)
15 main electronic circuit unit (ECU)
16 braking microcontroller
17a, b H-bridge-circuits

1. A control apparatus for an actuator arrangement of a vehicle, the control apparatus comprising:
a driver module for operating the actuator arrangement;
a first communication module for receiving first data; and
a second communication module for receiving second data,
wherein the control apparatus is adapted for controlling the actuator arrangement in a first operation mode on basis of the first data together with the second data, and
wherein the control apparatus is adapted for controlling the actuator arrangement in a second operation mode on basis of the second data from the second communication module without the first communication module.

2. The control apparatus according to claim 1,
wherein the actuator arrangement is adapted to be controlled by actuator commands,
wherein, in the first operation mode, the actuator commands are received by the first communication module, and
wherein, in the second operation mode, the actuator commands are received by the second communication module.

3. The control apparatus according to claim 2,
wherein the actuator arrangement is adapted to provide feedback data as a feedback to the actuator commands,
wherein, in the first operation mode, the feedback data is provided by the first communication module, and
wherein, in the second operation mode, the feedback data is provided by the second communication module.

4. The control apparatus according to claim 1, wherein the first communication module is a serial interface or wherein the second communication module is a parallel interface.

5. The control apparatus according to claim 1, wherein the driver module comprises two separate driver submodules adapted for operating two separate actuators of the actuator arrangement.

6. The control apparatus according to claim 5, wherein the driver module is adapted for receiving signals from the actuator arrangement or wherein the two separate driver submodules are adapted for receiving signals from the two separate actuators.

7. The control apparatus according to claim 1, wherein the actuator arrangement is a brake arrangement for the vehicle or wherein the actuators are brake actuators.

8. The control apparatus according to claim 1, further comprising a third communication module for receiving third data comprising high-level actuator commands from the driver or a human machine interface (HMI) in a third operation mode.

9. The control apparatus according to claim 1, further comprising a memory for storing parameters or variables, and wherein the first communication module is adapted to access the memory.

10. The control apparatus according to claim 1 wherein the control apparatus is an integrated circuit (IC).

11. The control apparatus according to claim 1, wherein the first operation mode is a highly automated parking (HAP) mode and the second operation mode is a HAP error mode.

12. A control_arrangement for an actuator arrangement of a vehicle, the control arrangement comprising:
a control apparatus; and
a data processing unit,
wherein the control apparatus includes:
a driver module for operating the actuator arrangement;
a first communication module for receiving first data; and
a second communication module for receiving second data,
wherein the control apparatus is adapted for controlling the actuator arrangement in a first operation mode on basis of the first data together with the second data,
wherein the control apparatus is adapted for controlling the actuator arrangement in a second operation mode on basis of the second data from the second communication module without the first communication module, and
wherein the data processing unit is connected to the first communication module and the second communication module.

13. The control arrangement according to claim 12, wherein the data processing unit is adapted for providing actuator commands and/or receiving feedback data from the first communication module in a first operation mode and for providing actuator commands or receiving feedback data from the second communication module in a second operation mode.

14. A process for controlling an actuator arrangement with a control apparatus including a driver module for operating the actuator arrangement, a first communication module for receiving first data, and a second communication module for receiving second data, the process comprising:
controlling the actuator arrangement in a first operation mode on basis of the first data together with the second data;
controlling the actuator arrangement in a second operation mode on basis of the second data from the second communication module without the first communication module; and
providing actuator commands or receiving feedback data from the first communication module in the first operation mode and from the second communication module in the second operation mode.
